(19) United States
(12) Patent Application Publication
(10) Pub. No.: US 2026/0270448 A1
(43) Pub. Date: Sep. 10, 2026

(54) VISUAL-TOKEN COMPRESSION FOR VIDEO UNDERSTANDING

(71) Applicant: QUALCOMM Incorporated, San Diego, CA (US)

(72) Inventors: Janghoon CHO, Seoul (KR); Sungha CHOI, Goyang-si (KR); Jungsoo LEE, Paju (KR)

(21) Appl. No.: 19/258,869

(22) Filed: Jul. 2, 2025

Related U.S. Application Data
(60) Provisional application No. 63/767,778, filed on Mar. 6, 2025.

(51) Int. Cl. H04N 19/172; G06V 10/74; G06V 20/40; G06V 20/70

(52) U.S. Cl. CPC H04N 19/172; G06V 10/761; G06V 20/44; G06V 20/70

(57) ABSTRACT

Systems and techniques are described herein for generating data based on video data. For instance, a method for generating data based on video data is provided. The method may include encoding each frame of a plurality of frames of video data to generate a plurality of visual tokens; selecting a subset of visual tokens from among the plurality of visual tokens; processing a query to generate a text embedding; and processing the subset of visual tokens and the text embedding using a large language model to generate a response to the query.

### CROSS-REFERENCE TO RELATED APPLICATIONS

This application claims the benefit of U.S. Provisional Application No. 63/767,778, filed Mar. 6, 2025, which is incorporated herein by reference in its entirety.

### TECHNICAL FIELD

The present disclosure generally relates to visual token compression. For example, aspects of the present disclosure include systems and techniques for visual-token compression for video understanding (e.g., for long videos).

### BACKGROUND

Recent Advances in Vision-Language Models (VLMs) have enabled the joint understanding of videos and text. Long-video understanding has recently gained attention as LVMs expand the capabilities of Large Language Models (LLMs) into the spatiotemporal domain. However, the sheer number of visual tokens in extended video sequences poses a significant bottleneck, especially given the input length limitations of most existing language and vision architectures.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for generating data based on video data. According to at least one example, a method is provided for generating data based on video data. The method includes: obtaining video data comprising a plurality of frames; encoding each frame of the plurality of frames to generate a plurality of visual tokens; selecting a subset of visual tokens from among the plurality of visual tokens; and processing a query and the subset of visual tokens using a large language model to generate a response.

In another example, an apparatus for generating data based on video data is provided that includes at least one memory and at least one processor (e.g., configured in circuitry) coupled to the at least one memory. The at least one processor configured to: obtain video data comprising a plurality of frames; encode each frame of the plurality of frames to generate a plurality of visual tokens; select a subset of visual tokens from among the plurality of visual tokens; and process a query and the subset of visual tokens using a large language model to generate a response.

In another example, a non-transitory computer-readable medium is provided that has stored thereon instructions that, when executed by one or more processors, cause the one or more processors to: obtain video data comprising a plurality of frames; encode each frame of the plurality of frames to generate a plurality of visual tokens; select a subset of visual tokens from among the plurality of visual tokens; and process a query and the subset of visual tokens using a large language model to generate a response.

In another example, an apparatus for generating data based on video data is provided. The apparatus includes: means for obtaining video data comprising a plurality of frames; means for encoding each frame of the plurality of frames to generate a plurality of visual tokens; means for selecting a subset of visual tokens from among the plurality of visual tokens; and means for processing a query and the subset of visual tokens using a large language model to generate a response.

In another example, a method is provided for generating data based on video data. The method includes: encoding each frame of a plurality of frames of video data to generate a plurality of visual tokens; selecting a subset of visual tokens from among the plurality of visual tokens; processing a query to generate a text embedding; and processing the subset of visual tokens and the text embedding using a large language model to generate a response to the query.

In another example, an apparatus for generating data based on video data is provided that includes at least one memory and at least one processor (e.g., configured in circuitry) coupled to the at least one memory. The at least one processor configured to: encode each frame of a plurality of frames of video data to generate a plurality of visual tokens; select a subset of visual tokens from among the plurality of visual tokens; process a query to generate a text embedding; and process the subset of visual tokens and the text embedding using a large language model to generate a response to the query.

In another example, a non-transitory computer-readable medium is provided that has stored thereon instructions that, when executed by one or more processors, cause the one or more processors to: encode each frame of a plurality of frames of video data to generate a plurality of visual tokens; select a subset of visual tokens from among the plurality of visual tokens; process a query to generate a text embedding; and process the subset of visual tokens and the text embedding using a large language model to generate a response to the query.

In another example, an apparatus for generating data based on video data is provided. The apparatus includes: means for encoding each frame of a plurality of frames of video data to generate a plurality of visual tokens; means for selecting a subset of visual tokens from among the plurality of visual tokens; means for processing a query to generate a text embedding; and means for processing the subset of visual tokens and the text embedding using a large language model to generate a response to the query.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system representing the structure of a Vision-Language Model (VLM);

FIG. 2A is a diagram illustrating an example system for compressing visual tokens, according to various aspects of the present disclosure;

FIG. 2B is a diagram illustrating an alternative representation of the system of FIG. 2A, according to various aspects of the present disclosure;

FIG. 3 includes a representation of an example facility-location problem to provide intuition regarding a facility-location function;

FIG. 4 through FIG. 6 include representations of an example facility-location problem in combinatorial optimization to provide intuition regarding a optimizing a facility-location function;

FIG. 7 illustrates a graph to provide context for a description of a graph-partitioning-based technique for visual-token compression, according to various aspects of the present disclosure;

FIG. 8A is a flow diagram illustrating an example process for generating data based on video data, in accordance with aspects of the present disclosure;

FIG. 8B is a flow diagram illustrating another example process for generating data based on video data, in accordance with aspects of the present disclosure;

FIG. 9 is a block diagram illustrating an example of a deep learning neural network that can be used to perform various tasks, according to some aspects of the disclosed technology;

FIG. 10 is a block diagram illustrating an example of a convolutional neural network (CNN), according to various aspects of the present disclosure;

FIG. 11 is a block diagram illustrating a multimodal generative ML system for generating natural language responses based on natural language input from a prompt and any additional information;

FIG. 12 includes an example machine-learning model that may be used in various aspects of the present disclosure;

FIG. 13 is a block diagram of an example transformer in accordance with some aspects of the disclosure; and

FIG. 14 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

With the recent emergence of Large Language Models (LLMs) in natural language processing, there has been a surge of interest in extending their capabilities to the visual domain. These Large Vision Models (LVMs) have already demonstrated performance surpassing human-level accuracy on vision tasks, such as visual question answering. More recently, the research focus has shifted toward enabling these models to understand video sequences, giving rise to Long Video Understanding models. Such models not only excel in tasks like captioning, event detection, and action recognition, but also show significant potential in various real-world applications, including surveillance through CCTV systems, immersive experiences in smart glasses, and autonomous navigation for mobile robots.

Despite this progress, video understanding remains particularly challenging due to the explosive growth in the number of visual tokens as the video sequence length increases. When dealing with high-resolution (e.g., 4K content) or long-duration videos (e.g., videos that are tens of minutes or more in length), it becomes computationally infeasible to process every token end-to-end, especially given that most LLM-based architectures support input contexts of only 4K to 32K tokens. This limitation is exacerbated in real-world scenarios: for instance, continuous CCTV footage can span days or weeks, smart glasses may capture extended, first-person video streams, and mobile robots frequently operate in dynamic environments requiring real-time video analysis. Consequently, the gap between human-level performance and current model capabilities still exists, highlighting the complexity and significance of this research direction.

To tackle the issue of handling long video sequences, visual-token compression is often used. In practice, when examining consecutive frames of a video, many tokens share highly redundant information unless there is a substantial scene change. Eliminating these redundancies often does not harm the downstream performance. However, excessively pruning tokens may leads to the loss of critical information. Therefore, an ideal compression algorithm must carefully select tokens to minimize information loss while still reducing the overall token count to a manageable level.

Various approaches have been proposed to address this problem. Some methods employ sampling-based strategies to select only the most salient frames, while others divide the video into multiple clips and extract keyframes or key tokens to represent each segment. Filtering of duplicate tokens or frames is also used. However, these existing methods often fail to guarantee both broad coverage and sufficient diversity of the original content. In some cases, they introduce additional overhead in ensuring that no crucial information is lost, leading to suboptimal performance in long video scenarios.

Systems, apparatuses, methods (also referred to as processes), and computer-readable media (collectively referred to herein as “systems and techniques”) are described herein for visual-token compression for video understanding, such as long-video understanding. For example, the systems and techniques described herein may include a visual-token compression algorithm based on a facility-location function. The systems and techniques interpret token selection through the lens of submodular optimization, ensuring that the selected set of tokens covers all original tokens under a given budget constraint. As a result, the chosen tokens are both representative and diverse, effectively preserving essential information for video understanding tasks.

The systems and techniques may include visual-token-compression framework based on a facility location function. The systems and techniques formulate token-selection as a submodular optimization problem that ensures both coverage and diversity within a given budget.

By leveraging a lazy greedy algorithm, the approach significantly reduces computational overhead while maintaining near-optimal solutions. Additionally, the systems and techniques are training-free and model-agnostic, making the systems and techniques easy to integrate into existing pipelines for various applications, such as long-form surveillance-video analysis, immersive smart glasses, and mobile robot navigation. The systems and techniques may achieves superior performance compared to existing compression methods. Thus, the systems and techniques are effective in addressing the challenges of long video understanding.

As examples, long-video understanding using VLMs may be useful for use cases related to artificial intelligence (AI) applications in smart glasses, closed-circuit television (CCTV), autonomous vehicles, and robotics. For example, extended reality (XR) (which may include virtual reality (VR), augmented reality (AR), and/or mixed reality (MR)) glasses capture video through onboard camera, enabling users to share their perspective in real time. However, effective communication may be benefitted by an understanding the present moment and retained reasoning over long-term video data. For example, it may be useful for an AI assistant in XR glasses to recall where you last placed your keys. In smart-glasses applications, the systems and techniques may enable understanding of endless streaming video, enhancing of real-time AR features, and extending battery life while preserving essential spatial-temporal information. In CCTV, the systems and techniques may enable real-time anomaly detection, large-scale security systems, and content-based retrieval. In autonomous vehicles and/or robotics, the systems and techniques may enable vision-information-based decision making.

Various aspects of the application will be described with respect to the figures below.

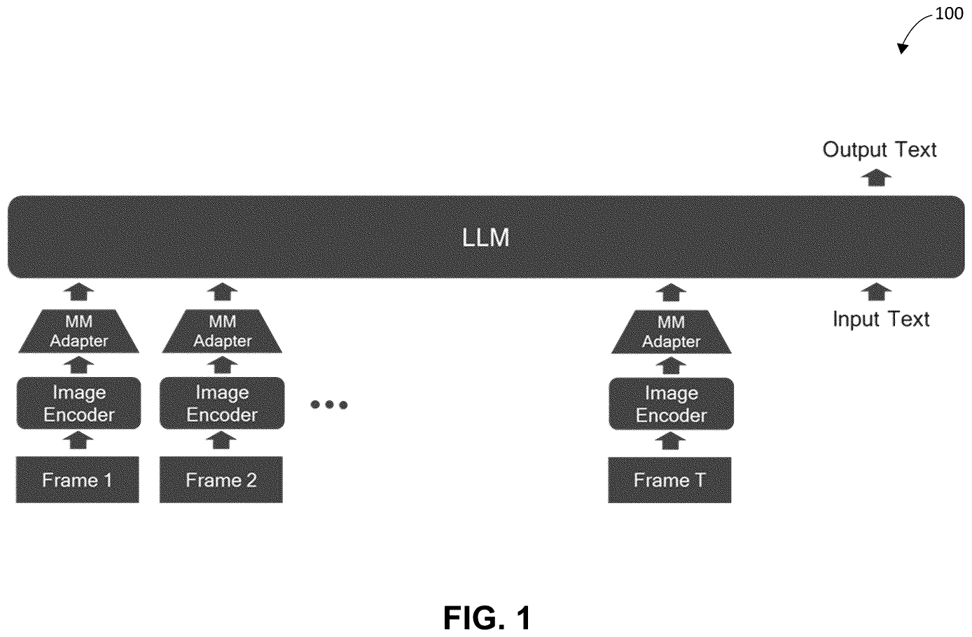

FIG. 1 is a block diagram illustrating an example system 100 representing the structure of a VLM. In general, system 100 may process frames of video data (e.g., Frame 1 to Frame T) using an image encoder to generate visual tokens. A multimodal (MM) adapter may adapt the visual tokens to be similar to text tokens. An LLM may process the adapted visual tokens and input text to generate output text.

When processing long videos (e.g., videos including tens of minutes of video data), several fundamental challenges arise. One challenge is visual token explosion. To input a video into a VLM, key visual features from each frame must be extracted and converted into visual tokens. In long videos (e.g., videos including tens of minute of data), the number of frames may be too large for the LLM, leading to an explosion of visual tokens that the model needs to process.

Another challenge of processing long videos is LLM context length limitations. Transformer-based LLMs typically support a limited number of tokens (e.g., 4,000-32,000). However, in long video scenarios, the number of generated visual tokens may far exceed this limit. For instance, consider a 10-minute video, sampled at 2 frames per seconds (fps), with 100 visual tokens per frame. 10 min×60 sec×2 frames×100 tokens=120,000 visual tokens. This is much larger than the typical context window of modern LLMs.

Yet another challenge of processing long videos is computational inefficiency. The larger the number of visual tokens, the higher the computational cost for inference. In mobile and edge-device scenarios, decreasing the number of tokens may be important for improving both efficiency and real-time performance.

| Video Duration | | 1 sec | | 1 min | 1 hour | | Sampling 1 fps |
|---|---|---|---|---|---|---|---|
| # of Tokens | | 144 | | 8.4K | 506K | | 144 visual tokens / frame |
| Llama- | Required | 36 | MB | 2.1 GB | 126 | GB | tokens# × 4K (D) × 32 (L) × 2 (B) |
| 3.1-8B | Memory | | | | | | |
| Llama- | Required | 9 | MB | 0.5 GB | 31.5 | GB | tokens# × 2K (D) × 16 (L) × 2 (B) |

| | |
|---|---|
| 3.2-1B | Memory |

For example, as illustrated by Table 1, at 1 frame per second (fps) and 144 visual tokes per frame, a 1 second video may result in 144 tokens, which may be stored in 36 Megabytes (MB) if processed by a first example LLM and 9 MB if processed by a second example LLM. Extending the example, a 1-minute video may result in 8400 tokens which may be stored in 2.1 Gigabytes (GB) if processed by the first example LLM and 0.5 GB if processed by the second example LLM. Extending the example, a 1-hour video may result in 506,000 tokens which may be stored in 126 GB if processed by the first example LLM and 31.5 GB if processed by the second example LLM.

To conserver memory and computational resources, the systems and techniques may compress visual tokens before feeding them into the VLMs.

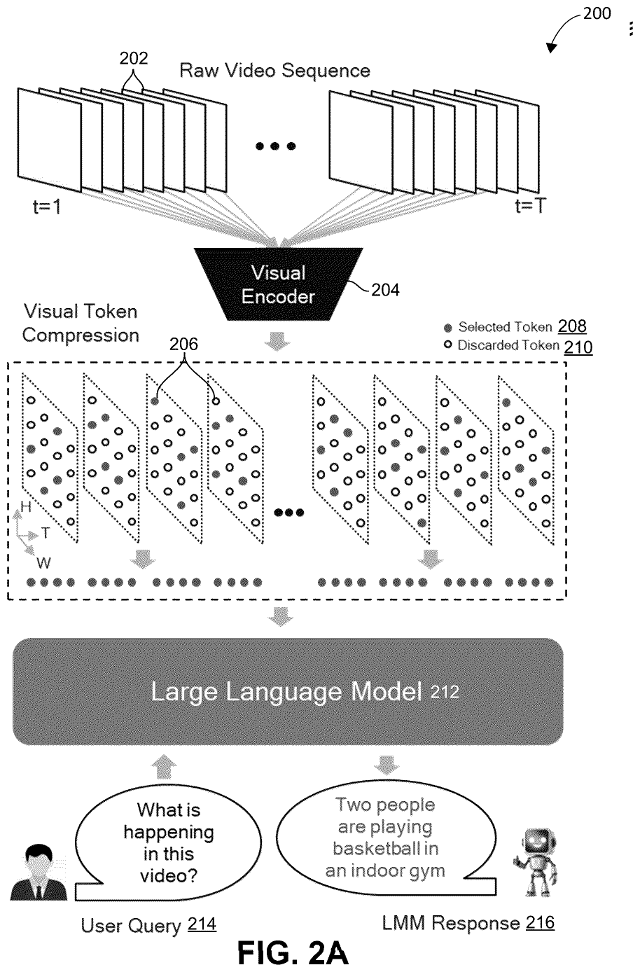

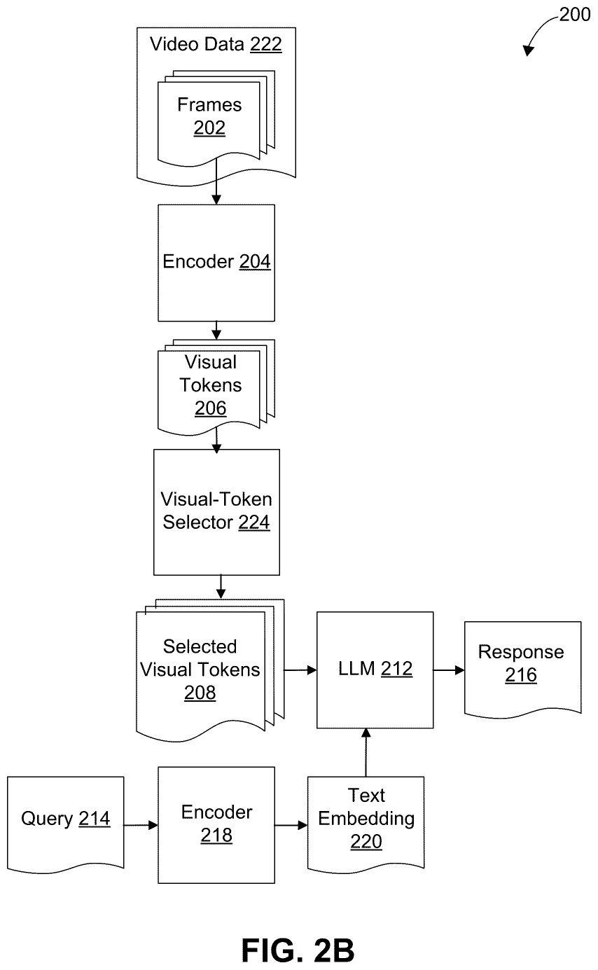

FIG. 2A is a diagram illustrating an example system 200 for compressing visual tokens, according to various aspects of the present disclosure. In general, system 200 may process frames 202 of video data using a visual encoder 204 to generate visual tokens 206. Further, system 200 may select some of the visual tokens (e.g., selected visual tokens 208) and discard others of the visual tokens (e.g., discarded visual tokens 210). In some aspects, selected visual tokens 208 may be adapted (e.g., using a multimodal adapter not illustrated in FIG. 2A). An LLM 212 may process the selected (and adapted) visual tokens along with a query 214 to generate a response 216.

FIG. 2B is a block diagram illustrating an alternative representation of system 200, according to various aspects of the present disclosure. System 200 may obtain video data 222. Video data 222 may be, or may include, a number of frames 202. Encoder 204 may encode frames 202 to generate visual tokens 206. Visual tokens 206 may include a plurality of visual tokens based on each frame of frames 202.

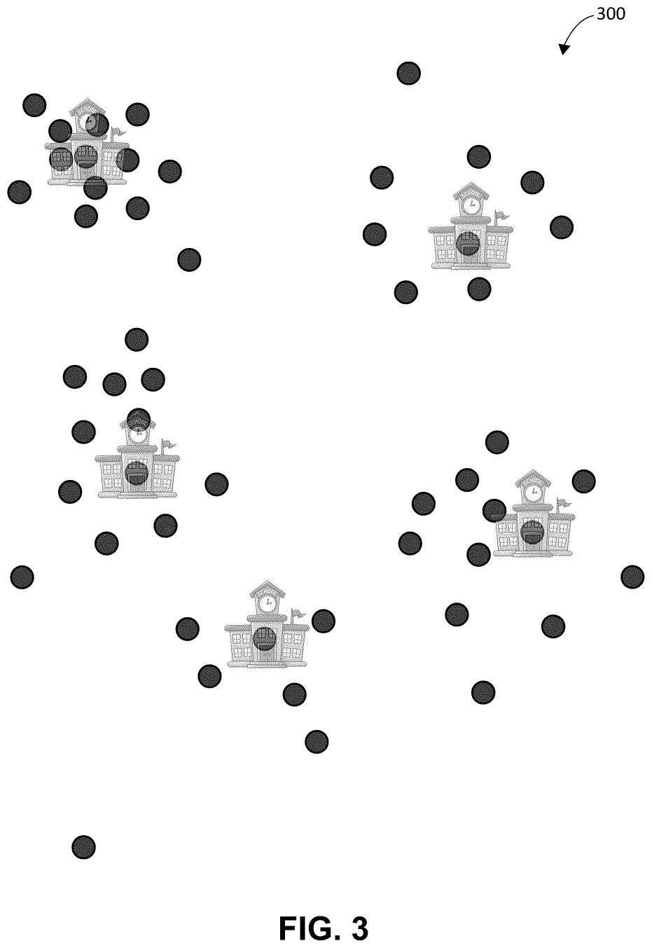

Visual-token selector 224 may select selected visual tokens 208 from among visual tokens 206. In some aspects, visual-token selector 224 may select selected visual tokens 208 based on a facility-location function, for example, as illustrated and described with regard to FIG. 3 through FIG. 6. In some aspects, visual-token selector 224 may select selected visual tokens 208 based on a utility function. For example, visual-token selector 224 may select selected visual tokens 208 to maximize a utility function. In some aspects, visual-token selector 224 may select selected visual tokens 208 based on a coverage function. For example, visual-token selector 224 may select selected visual tokens 208 to maximize a coverage function.

In some aspects, visual-token selector 224 may select selected visual tokens 208 based on a similarity between selected tokens of the subset of visual tokens. For example, visual-token selector 224 may select selected visual tokens 208 to maximize a similarity between selected visual tokens 208 (e.g., between all of selected visual tokens 208). For instance, visual-token selector 224 may select selected visual tokens 208 iteratively such that newly-selected ones of selected visual tokens 208 have a highest similarity with previously-selected ones of selected visual tokens 208.

In some aspects, visual-token selector 224 may select selected visual tokens 208 based on similarity between unselected visual tokens unselected visual tokens 210 of plurality of visual tokens. For instance, visual-token selector 224 may select selected visual tokens 208 iteratively such that unselected ones of visual tokens 206 (e.g., unselected visual tokens 210) have a similarity with visual tokens 206 which remain unselected.

In some aspects, visual-token selector 224 may select selected visual tokens 208 iteratively according to a greedy algorithm. In some aspects, visual-token selector 224 may select selected visual tokens 208 iteratively based on a highest marginal gain for selecting a next token for inclusion in the subset of visual tokens. In some aspects, visual-token selector 224 may select selected visual tokens 208 based on iteratively according to a lazy greedy algorithm.

Naïve approaches to token reduction include spatial pooling, temporal pooling, and uniform token sampling. Such approaches have limitations, for example, important frames containing key actions or transitions may be excluded or blurred, leading to information loss and degraded model performance.

Clustering-based approaches to token reduction may group similar frames or features and select representative tokens from each cluster. Clustering-based approaches have limitations. For example, clustering-based approaches can fail to preserve spatial-temporal position information, leading to potential loss of motion coherence and scene structure.

Query-dependent approaches to token reduction may discard or compress visual tokens unrelated to the given query. Query-dependent approaches have limitations. For example, query-dependent approaches may be ineffective for new queries. A new query can be related to previously discarded or compressed visual tokens.

Learnable compression approaches to token reduction may use learnable models to identify and retain the most important visual tokens dynamically. Learnable compression approaches have limitations. For example, learnable compression approaches require additional training and may also generalize poorly to unseen videos.

System 200 may implement a coverage-based visual-token compression. The coverage-based visual-token compression may define a problem as a subset selection. The coverage-based visual-token compression may choose the subset of visual tokens based on:

$$S *= arg {max}_{S ⊆ V , \vert S \vert \leq K} f ( S ) .$$

Let V={v₁, v₂, . . . , vₙ} be the ground set of all visual tokens extracted from a raw video. Each token vᵢ represents a feature vector corresponding to a specific spatiotemporal segment (e.g., a frame patch at a given time). The goal of coverage-based visual-token compression may be to select a subset S⊆V such that |S|≤K, where K is a budget on the number of tokens to keep. Formally, coverage-based visual-token compression seeks to find the subset S that maximizes a utility (or coverage) function ƒ:

$$S *= arg {max}_{S ⊆ V , \vert S \vert \leq K} f ( S ) .$$

Here, ƒ(S) quantifies how well the chosen tokens in S collectively represent or cover the entire set V. In other words, f should reward subsets that preserve the essential information and diversity of the original token set, while respecting the budget constraint K. The challenge lies in designing and optimizing a suitable function ƒ that captures the core video content with minimal redundancy.

In the subsequent stage, the subset of visual tokens selected by coverage-based visual-token compression is concatenated with a user-provided text prompt to form the final input for the Large Language Model. As illustrated in FIG. 2A and FIG. 2B, the raw video is first parsed into a large set of tokens (e.g., tokens 206), from which coverage-based visual-token compression selects a representative and diverse subset (e.g., selected visual tokens 208). This chosen subset is then combined with tokens based on the prompt text (e.g., query 214), ensuring that the model receives sufficient contextual information about the visual content. In doing so, system 200 integrates visual cues with linguistic context, enabling the LLM to perform downstream tasks such as captioning, question answering, or event detection with improved efficiency and accuracy.

System 200 may use a facility-location function. The facility-location function is a submodular function in combinatorial optimization addressing the problem of selecting representative elements (e.g., centers, center points) from a given dataset. The facility-location function is particularly useful in tasks such as summarization, sensor placement, clustering, and information retrieval.

FIG. 3 includes a representation 300 of an example facility-location problem to provide intuition regarding a facility-location function. For example, each of the circles represents a location with demands. Each of the schools represents a facility positioned to meet the demands of the circles.

By maximizing a facility-location function in visual-token compression, the selected subset is encouraged to cover all tokens in the original set as comprehensively as possible. Additionally, maximizing the facility-location function in visual-token compression can avoid redundancy by penalizing highly overlapping regions.

Returning to FIG. 2A and FIG. 2B, system 200 may use the facility-location function to select a representative and diverse subset of visual tokens (e.g., selected visual tokens 208). Formally, given a ground set V of visual tokens, the facility location objective is defined as follows:

$$f ( S ) = {\sum }_{v ∈ V} {max}_{u ∈ S} sim ( v , u ) ,$$

where sim(v, u) denotes the similarity between tokens v and u. System 200 may employ cosine similarity between token embeddings as our similarity measure:

$$sim ( v , u ) = \frac{{v}^{T} u}{‖ v ‖ ‖ u ‖}$$

System 200 may use the facility-location function based on its effectiveness in balancing representativeness and diversity. By maximizing the facility-location function, the selected subset is encouraged to cover all tokens in the original set as comprehensively as possible, while avoiding redundancy by penalizing highly overlapping selections. Due to this property, facility location has been successfully applied across various summarization domains, including document summarization, image summarization, and video summarization tasks.

Finding an optimal subset that maximizes the facility location function is known to be NP-hard. To address this complexity, system 200 may employ the greedy algorithm, which iteratively selects tokens with the highest marginal gain until the budget constraint is satisfied. This greedy selection method guarantees a solution with a performance lower bound of (1−1/e)≈0.632 relative to the optimal solution. Specifically, the greedy algorithm incrementally adds the token that provides the largest increase in coverage at each iteration. To further enhance computational efficiency, system 200 may implement a lazy greedy algorithm, which significantly reduces the computational overhead by postponing the update of marginal gains until absolutely necessary, thus allowing efficient subset selection even for very large token sets.

Algorithm 1 Lazy Greedy Algorithm for Facility Location

| Require: Ground set V, budget K, facility location function f | |
|---|---|
| Ensure: Selected subset S with \|S\| ≤ K | |
| 1: | S ← Ø |
| 2: | Initialize priority queue Q ← Ø |
| 3: | for v ∈ V do |
| 4: | Δᵥ ← f({v}) |
| 5: | Insert v into Q with priority Δᵥ |
| 6: | end for |
| 7: | while \|S\| < K do |
| 8: | v* ← arg max_{v∈Q} Δᵤ (pop from queue) |
| 9: | δ ← f(S ∪ {v*}) − f(S) |
| 10 | if δ ≥ max_{v∈Q} Δᵤ then |
| 11: | S ← S ∪ {v*} |
| 12 | else |
| 13: | Update priority of v* in Q to δ and re-insert |
| 14 | end if |
| 15: | end while |
| | return S |

The lazy greedy algorithm significantly reduces computational complexity compared to the naive greedy approach. While the naive greedy algorithm for maximizing submodular functions has a time complexity of O(nK), the lazy greedy approach leverages the submodularity property to avoid unnecessary recomputation of marginal gains. By using a priority queue, the lazy greedy algorithm updates marginal gains only when needed, achieving empirical speedups often approaching an order of magnitude. Consequently, the lazy greedy algorithm is particularly efficient for handling numerous visual tokens and enabling real-time processing of long videos.

Compared to traditional clustering-based methods such as k-means and spectral clustering, the lazy greedy-based facility location method offers several advantages. First, the lazy greedy-based facility location method eliminates iterative refinement and costly operations such as eigen-decompositions. Instead, the lazy greedy-based facility location method directly selects tokens in a single forward pass by maximizing global coverage, ensuring a diverse and representative subset is chosen efficiently. Thus, the lazy greedy-based facility location method provides a highly-efficient and scalable alternative, especially suitable for real-time or on-device processing requirements. Next, the facility location function explicitly optimizes global coverage by selecting tokens that best represent the entire set of visual tokens. Unlike k-means, which tends to select tokens from dense regions and may overlook sparsely populated yet important regions (e.g., example, rare object, fine-grained details . . . ), the facility location method ensures that selected tokens span diverse feature regions by defining utility in terms of coverage, prioritizing selections that maximize representativeness. This prevents oversampling from dense clusters while preserving rare but meaningful patterns.

The lazy greedy-based facility location algorithm may outperform traditional clustering methods, such as k-means and spectral clustering, in terms of computational efficiency. Specifically, the lazy greedy-based facility location method may provide runtime improvements, achieving speedups of several times or more depending on the dataset size and scenario.

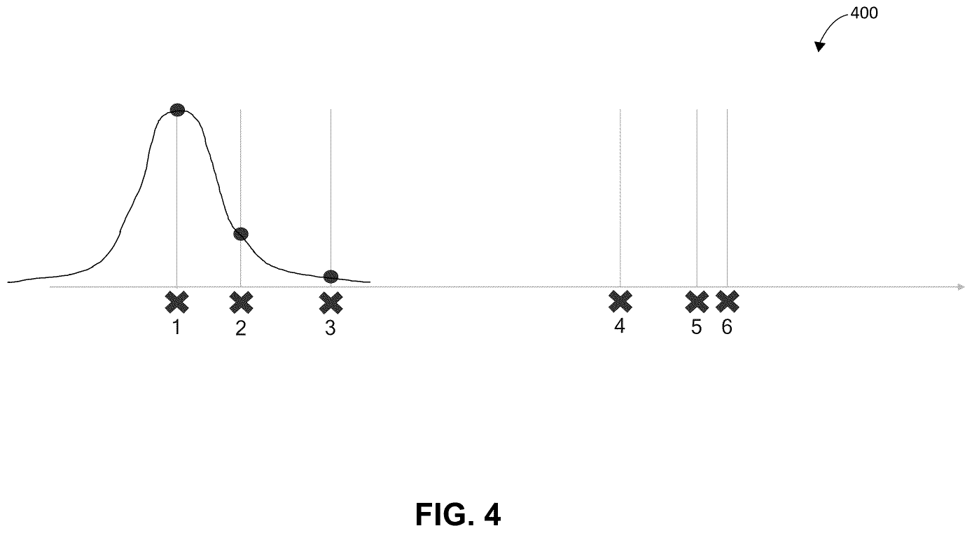

FIG. 4 through FIG. 6 include representations of an example facility-location problem in combinatorial optimization to provide intuition regarding a optimizing a facility-location function. Optimizing the facility-location function may include determining how close each data point $i$ is to the most similar element in the selected subset $S$.

$$f ( S ) = {\sum }_{i ∈ V} {max}_{j ∈ s} sim ( i , j ) ,$$

$$V = \{ 1 , 2 , 3 , 4 , 5 , 6 \}$$

$$\vert S \vert = 2$$

FIG. 4 illustrates a graph representing:

$$f ( \{ 1 \} ) = {\sum }_{i - 1 , … , 6} sim ( i , 1 )$$

For example, FIG. 4 illustrates a similarity between a first token and all other tokens.

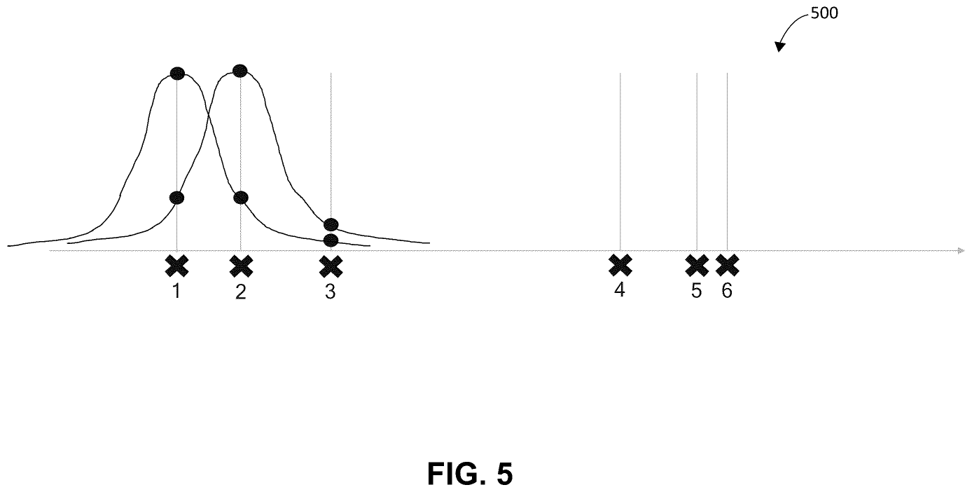

FIG. 5 illustrates

$$f ( \{ 1 , 2 \} ) = {\sum }_{i - 1 , … , 6} max ( s i m ( i , 1 ) , sim ( i , 2 ) )$$

$$\hat{S} = {arg}_{\vert S \vert = 2} max F ( S )$$

For example, FIG. 5 illustrates a similarity between a first token and all other tokens and a similarity between a second token and all other tokens.

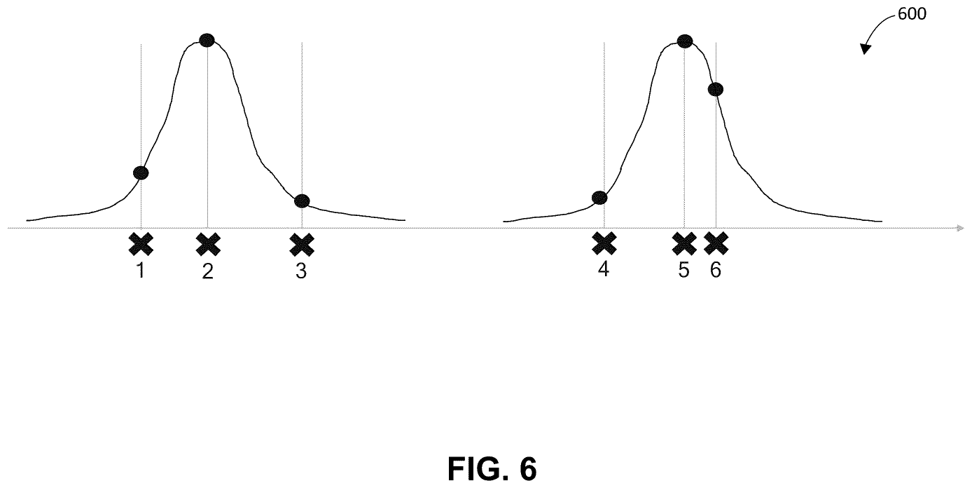

FIG. 6 illustrates

$$f ( \{ 1 , 2 \} ) = {\sum }_{i - 1 , … , 6} max ( s i m ( i , 1 ) , sim ( i , 2 ) )$$

$$\hat{S} = {arg}_{\vert S \vert = 2} max F ( S )$$

For example, FIG. 6 illustrates a similarity between a second token and all other tokens and a similarity between a fifth token and all other tokens.

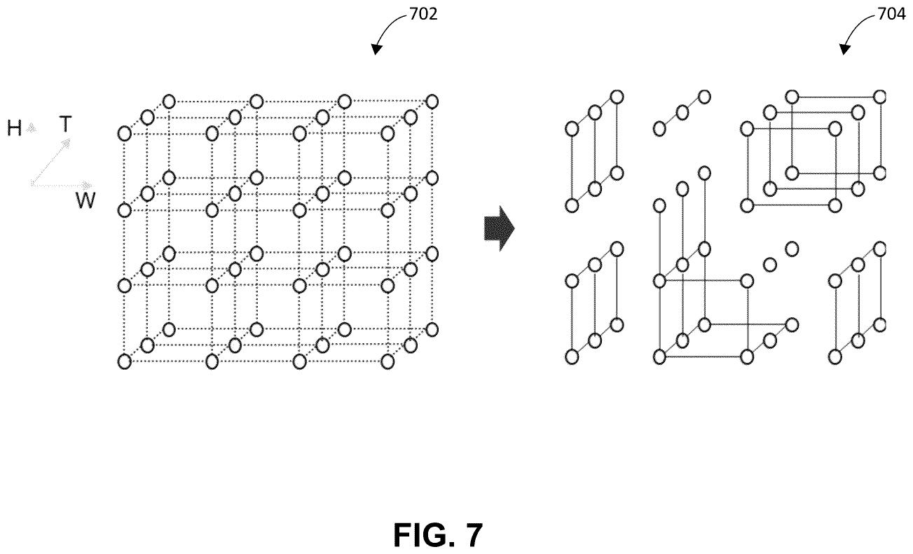

FIG. 7 illustrates a graph to provide context for a description of a graph-partitioning-based technique for visual-token compression, according to various aspects of the present disclosure. In some aspects, system 200 may compress visual tokens according to graph-partitioning-based technique. According to the graph-partitioning-based technique for visual-token compression, system 200 may group visual tokens which are spatio-temporally and semantically similar. For example, system 200 may construct a graph (e.g., graph 702). Such a graph may include nodes in three dimensions, including a height and width dimension that may correspond to pixel dimensions of the image frames from which the tokens were extracted. Additionally, the graph may include a temporal or frame dimension. Each node of the graph may be a visual token. Each edge of the graph may be between spatio-temporally adjacent nodes. Edge values can be calculated as cosine similarities of node pairs.

After constructing such a graph (e.g., graph 702) based on the tokens, system 200 may apply a graph-partitioning algorithm to partition the graph into partitions (e.g., as represented by graph 704). As examples, system 200 may implement spectral clustering, min cut, community detection (Louvain Method), METIS (Multilevel Graph Partitioning), affinity propagation, or Markov clustering. Such partitioning may effectively reduce redundancy while preserving essential spatio-temporal structure, enabling more efficient long video processing.

Having determined partitions, system 200 may determine a token to represent each partition and select the determined tokens. System 200 may combine the selected tokens with the input text and process the input text with the selected tokens.

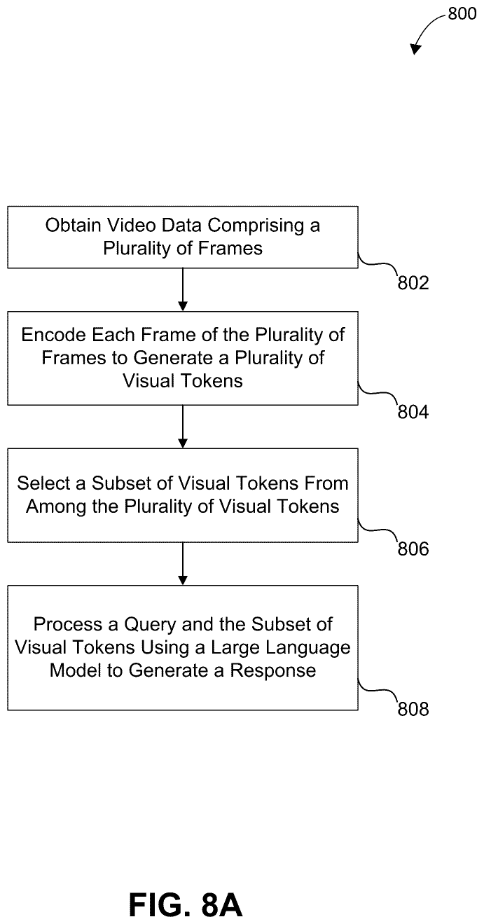

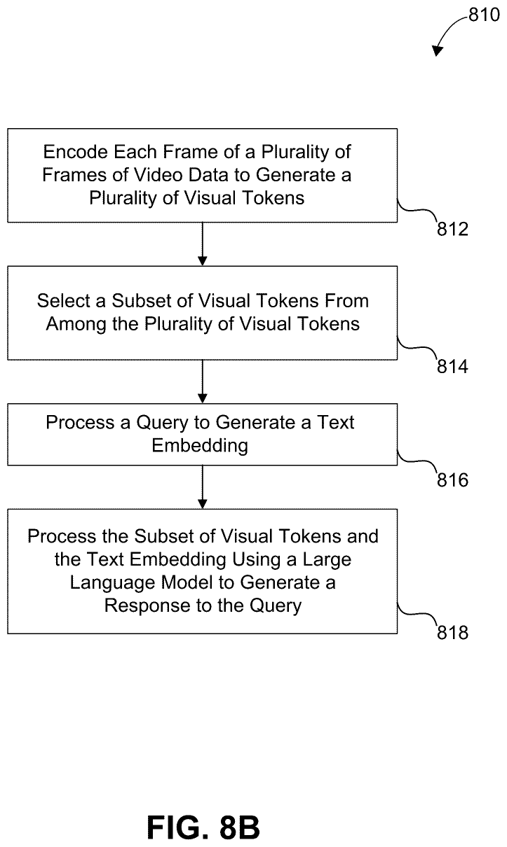

FIG. 8A is a flow diagram illustrating an example process 800 for generating data based on video data, in accordance with aspects of the present disclosure. One or more operations of process 800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 800. The one or more operations of process 800 may be implemented as software components that are executed and run on one or more processors.

At block 802, a computing device (or one or more components thereof) may obtain video data comprising a plurality of frames. For example, system 200 may obtain a raw video sequence. The raw video sequence may include a plurality of frames (e.g., frames 202).

At block 804, the computing device (or one or more components thereof) may encode each frame of the plurality of frames to generate a plurality of visual tokens. For example, a visual encoder of system 200 may encode each frame of frames 202 to generate a respective group of visual tokens (e.g., respective sets of visual tokens 206). In FIG. 2A, circles in the parallelograms near the middle of FIG. 2A represent sets of visual tokens per frame of the raw video sequence. Each circle, filled or not, represents a visual token. The position of the circles on the parallelogram indicates that each visual token relates to a position within a corresponding frame. The number of parallelograms arranged side by side indicates that each set of parallelograms relates to a frame (e.g., that corresponds to a time).

At block 806, the computing device (or one or more components thereof) may select a subset of visual tokens from among the plurality of visual tokens. For example, system 200 may select selected visual tokens 208 from among the plurality of visual tokens. For example, the filled circles of the visual tokens represent selected visual tokens. The empty circles represent unselected (“discarded”) tokens.

In some aspects, the subset of visual tokens are selected from among the plurality of visual tokens based on a facility-location function. For example, system 200 may select selected visual tokens 208 based on a facility-location function.

In some aspects, the subset of visual tokens may be selected from among the plurality of visual tokens to maximize a utility function. For example, system 200 may select selected visual tokens 208 to maximize a utility function.

In some aspects, the subset of visual tokens may be selected from among the plurality of visual tokens to maximize a utility function. For example, system 200 may select selected visual tokens 208 to maximize a coverage function.

In some aspects, the subset of visual tokens may be selected from among the plurality of visual tokens to maximize a cosine similarity between selected tokens of the subset of visual tokens and unselected tokens of plurality of visual tokens. For example, system 200 may select selected visual tokens 208 to maximize a cosine similarity between selected visual tokens 208 of the subset of visual tokens and unselected visual tokens 210 of plurality of visual tokens.

For example, system 200 may select the subset of visual tokens based on:

$$S *= arg {max}_{S ⊆ V , \vert S \vert \leq K} f ( S ) .$$

where V={v₁, v₂, . . . , vₙ} represents the ground set of all visual tokens extracted from a raw video. Each token vᵢ represents a feature vector corresponding to a specific spatiotemporal segment (e.g., a frame patch at a given time). The goal of coverage-based visual-token compression may be to select a subset S⊆V such that |S|≤K, where K is a budget on the number of tokens to keep. Formally, coverage-based visual-token compression seeks to find the subset S that maximizes a utility (or coverage) function ƒ.

Formally, given a ground set V of visual tokens, the facility location objective is defined as follows:

$$f ( S ) = {\sum }_{v ∈ V} {max}_{u ∈ S} sim ( v , u ) ,$$

where sim(v, u) denotes the similarity between tokens v and u. System 200 may employ cosine similarity between token embeddings as our similarity measure:

$$sim ( v , u ) = \frac{{v}^{T} u}{‖ v ‖ ‖ u ‖}$$

In some aspects, the subset of visual tokens may be selected from among the plurality of visual tokens iteratively according to a greedy algorithm. For example, system 200 may select selected visual tokens 208 iteratively according to a greedy algorithm.

In some aspects, the subset of visual tokens may be selected from among the plurality of visual tokens iteratively based on a highest marginal gain for selecting a next token for inclusion in the subset of visual tokens. For example, system 200 may select selected visual tokens 208 iteratively based on a highest marginal gain for selecting a next token for inclusion in the subset of visual tokens.

In some aspects, the subset of visual tokens may be selected from among the plurality of visual tokens iteratively according to a lazy greedy algorithm. For example, system 200 may select selected visual tokens 208 iteratively according to a lazy greedy algorithm.

At block 808, the computing device (or one or more components thereof) may process a query and the subset of visual tokens using a large language model to generate a response. For example, system 200 may provide selected visual tokens 208 to large language model 212. Additionally, a user may provide a query (e.g., “user query 214”). Large language model 212 may process selected visual tokens 208 and query 214 to generate response 216 (e.g., “LLM response 216”).

In some aspects, the computing device (or one or more components thereof) may concatenate the subset of visual tokens with a text embedding based on the query and process the concatenated subset of visual tokens and text embedding using the large language model. For example, system 200 may encode query 214 as text embedding and combine (e.g., concatenate) the text embedding with selected visual tokens 208. System 200 may cause large language model 212 to process the concatenated text embedding and selected visual tokens 208.

In some aspects, the computing device (or one or more components thereof) may perform at least one of captioning, question answering, or event detection based on the video data. For example, large language model 212 may generate captions for the video data, generate an answer to query 214, and/or describe events that are represented in the video data.

For example, system 200 may select the subset of visual tokens according to Algorithm 1.

FIG. 8B is a flow diagram illustrating an example process 810 for generating data based on video data, in accordance with aspects of the present disclosure. One or more operations of process 810 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 810. The one or more operations of process 810 may be implemented as software components that are executed and run on one or more processors.

At block 812, a computing device (or one or more components thereof) may encode each frame of a plurality of frames of video data to generate a plurality of visual tokens. For example, encoder 204 may encode frames 202 of video data 222 to generate visual tokens 206.

At block 814, the computing device (or one or more components thereof) may select a subset of visual tokens from among the plurality of visual tokens. For example, visual-token selector 224 may select selected visual tokens 208 from among visual tokens 206.

At block 816, the computing device (or one or more components thereof) may process a query to generate a text embedding. For example, encoder 218 may process query 214 to generate text embedding 220.

At block 818, the computing device (or one or more components thereof) may process the subset of visual tokens and the text embedding using a large language model to generate a response to the query. For example, LLM 212 may process selected visual tokens 208 and text embedding 220 to generate response 216.

In some aspects, the computing device (or one or more components thereof) may combine the subset of visual tokens with the text embedding; and process the combined subset of visual tokens and the text embedding using the large language model to generate the response to the query. For example, prior to processing selected visual tokens 208 and text embedding 220, system 200 may combine (e.g., concatenate) selected visual tokens 208 and text embedding 220.

In some aspects, the computing device (or one or more components thereof) may perform at least one of captioning, question answering, or event detection based on the video data. For example, system 200 may perform captioning, question answering, and/or event detection based on video data 222.

In some aspects, the response may be, or may include, a caption for the video data. For example, response 216 may be, or may include, a caption for video data 222 (e.g., a video descriptive caption describing video data 222).

In some aspects, the response may be, or may include, an answer to a question of the query based on the video data. For example, query 214 may be, or may include, a question and response 216 may be, or may include, a response to the question.

In some aspects, the response may be, or may include, a label related to an event detected in the video data. For example, response 216 may be, or may include, a label related to an event detected in video data 222.

In some aspects, the computing device (or one or more components thereof) may to select the subset of visual tokens from among the plurality of visual tokens based on a facility-location function. For example, visual-token selector 224 may select selected visual tokens 208 from among visual tokens 206 based on a facility-location function.

In some aspects, the computing device (or one or more components thereof) may select the subset of visual tokens from among the plurality of visual tokens based on a utility function. For example, visual-token selector 224 may select selected visual tokens 208 from among visual tokens 206 based on a utility function.

In some aspects, the computing device (or one or more components thereof) may select the subset of visual tokens from among the plurality of visual tokens based on a coverage function. For example, visual-token selector 224 may select selected visual tokens 208 from among visual tokens 206 based on a coverage function.

In some aspects, the computing device (or one or more components thereof) may select the subset of visual tokens from among the plurality of visual tokens based on a similarity between selected tokens of the subset of visual tokens. For example, visual-token selector 224 may select selected visual tokens 208 from among visual tokens 206 based on a similarity between selected tokens of the subset of visual tokens.

In some aspects, the computing device (or one or more components thereof) may select the subset of visual tokens from among the plurality of visual tokens further based on a similarity between unselected tokens of plurality of visual tokens. For example, visual-token selector 224 may select selected visual tokens 208 from among visual tokens 206 based on a similarity between unselected tokens of plurality of visual tokens.

In some aspects, the computing device (or one or more components thereof) may select the subset of visual tokens from among the plurality of visual tokens iteratively according to a greedy algorithm. For example, visual-token selector 224 may select selected visual tokens 208 from among visual tokens 206 according to a greedy algorithm.

In some aspects, the computing device (or one or more components thereof) may select the subset of visual tokens from among the plurality of visual tokens iteratively based on a highest marginal gain for selecting a next token for inclusion in the subset of visual tokens. For example, visual-token selector 224 may select selected visual tokens 208 from among visual tokens 206 iteratively based on a highest marginal gain for selecting a next token for inclusion in the subset of visual tokens.

In some aspects, the computing device (or one or more components thereof) may select the subset of visual tokens from among the plurality of visual tokens iteratively according to a lazy greedy algorithm. For example, visual-token selector 224 may select selected visual tokens 208 from among visual tokens 206 iteratively according to a lazy greedy algorithm.

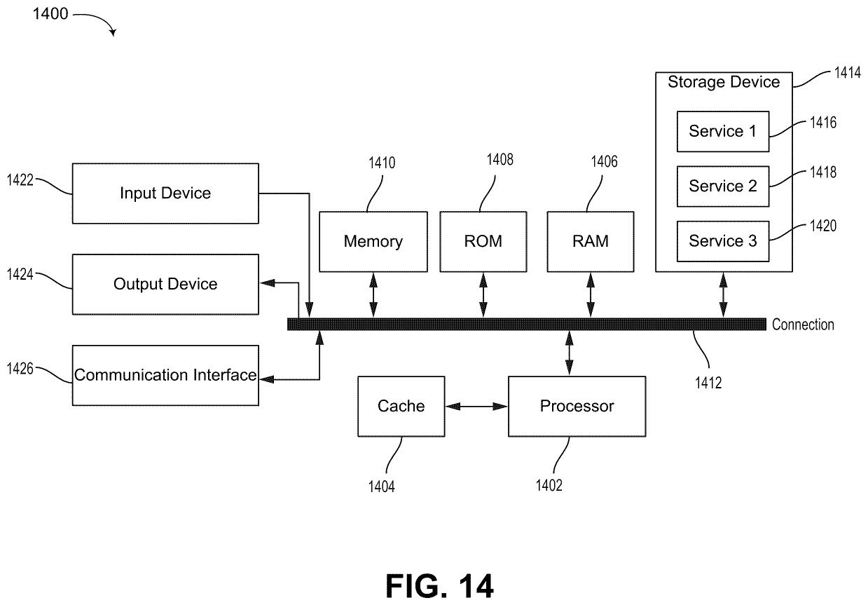

In some examples, as noted previously, the methods described herein (e.g., process 800 of FIG. 8A, process 810 of FIG. 8B, and/or other methods described herein) can be performed, in whole or in part, by a computing device or apparatus. In one example, one or more of the methods can be performed by system 200 of FIG. 2A and FIG. 2B, or by another system or device. In another example, one or more of the methods (e.g., process 800, process 810, and/or other methods described herein) can be performed, in whole or in part, by the computing-device architecture 1400 shown in FIG. 14. For instance, a computing device with the computing-device architecture 1400 shown in FIG. 14 can include, or be included in, the components of the system 200 and can implement the operations of process 800, process 810, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 800, process 810, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 800, process 810, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

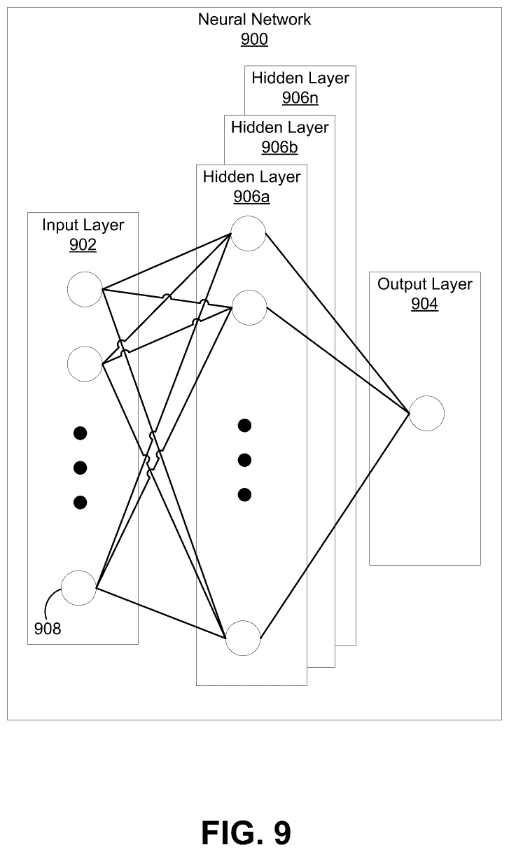

FIG. 9 is an illustrative example of a neural network 900 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 900 may be an example of, or can implement, an image encoder of FIG. 1 and/or a visual encoder 204 of FIG. 2A and FIG. 2B.

An input layer 902 includes input data. In one illustrative example, input layer 902 can include data such as text data, numerical data, image data, audio data, video data, etc. Neural network 900 includes multiple hidden layers, for example, hidden layers 906a, 906b, through 906n. The hidden layers 906a, 906b, through hidden layer 906n include “n” number of hidden layers, where “n” is an integer greater than or equal to one. The number of hidden layers can be made to include as many layers as needed for the given application. Neural network 900 further includes an output layer 904 that provides an output resulting from the processing performed by the hidden layers 906a, 906b, through 906n. In one illustrative example, output layer 904 can output data such as text data, numerical data, image data, audio data, video data, etc.

Neural network 900 may be, or may include, a multi-layer neural network of interconnected nodes. Each node can represent a piece of information. Information associated with the nodes is shared among the different layers and each layer retains information as information is processed. In some cases, neural network 900 can include a feed-forward network, in which case there are no feedback connections where outputs of the network are fed back into itself. In some cases, neural network 900 can include a recurrent neural network, which can have loops that allow information to be carried across nodes while reading in input.

Information can be exchanged between nodes through node-to-node interconnections between the various layers. Nodes of input layer 902 can activate a set of nodes in the first hidden layer 906a. For example, as shown, each of the input nodes of input layer 902 is connected to each of the nodes of the first hidden layer 906a. The nodes of first hidden layer 906a can transform the information of each input node by applying activation functions to the input node information. The information derived from the transformation can then be passed to and can activate the nodes of the next hidden layer 906b, which can perform their own designated functions. Example functions include convolutional, up-sampling, data transformation, and/or any other suitable functions. The output of the hidden layer 906b can then activate nodes of the next hidden layer, and so on. The output of the last hidden layer 906n can activate one or more nodes of the output layer 904, at which an output is provided. In some cases, while nodes (e.g., node 908) in neural network 900 are shown as having multiple output lines, a node has a single output and all lines shown as being output from a node represent the same output value.

In some cases, each node or interconnection between nodes can have a weight that is a set of parameters derived from the training of neural network 900. Once neural network 900 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 900 to be adaptive to inputs and able to learn as more and more data is processed.

Neural network 900 may be pre-trained to process the features from the data in the input layer 902 using the different hidden layers 906a, 906b, through 906n in order to provide the output through the output layer 904. In an example in which neural network 900 is used to identify features in images, neural network 900 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 900 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 900 is trained well enough so that the weights of the layers are accurately tuned.

For the example of identifying objects in images, the forward pass can include passing a training image through neural network 900. The weights are initially randomized before neural network 900 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 900, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 900 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target-output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 900 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ·ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 900 can include any other deep network other than a CNN, such as an autoencoder, a deep belief nets (DBNs), a Recurrent Neural Networks (RNNs), among others.

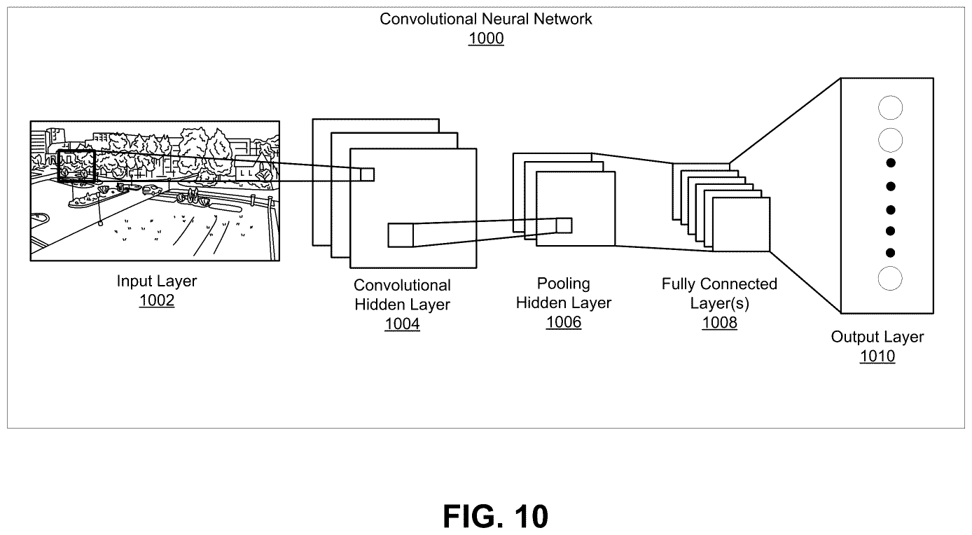

FIG. 10 is an illustrative example of a convolutional neural network (CNN) 1000. The input layer 1002 of the CNN 1000 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1004, an optional non-linear activation layer, a pooling hidden layer 1006, and fully connected layer 1008 (which fully connected layer 1008 can be hidden) to get an output at the output layer 1010. While only one of each hidden layer is shown in FIG. 10, one of ordinary skill will appreciate that multiple convolutional hidden layers, non-linear layers, pooling hidden layers, and/or fully connected layers can be included in the CNN 1000. As previously described, the output can indicate a single class of an object or can include a probability of classes that best describe the object in the image.

The first layer of the CNN 1000 can be the convolutional hidden layer 1004. The convolutional hidden layer 1004 can analyze image data of the input layer 1002. Each node of the convolutional hidden layer 1004 is connected to a region of nodes (pixels) of the input image called a receptive field. The convolutional hidden layer 1004 can be considered as one or more filters (each filter corresponding to a different activation or feature map), with each convolutional iteration of a filter being a node or neuron of the convolutional hidden layer 1004. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1004. Each connection between a node and a receptive field for that node learns a weight and, in some cases, an overall bias such that each node learns to analyze its particular local receptive field in the input image. Each node of the convolutional hidden layer 1004 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1004 is due to each node of the convolutional layer being applied to its corresponding receptive field. For example, a filter of the convolutional hidden layer 1004 can begin in the top-left corner of the input image array and can convolve around the input image. As noted above, each convolutional iteration of the filter can be considered a node or neuron of the convolutional hidden layer 1004. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1004. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1004.

The mapping from the input layer to the convolutional hidden layer 1004 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1004 can include several activation maps in order to identify multiple features in an image. The example shown in FIG. 10 includes three activation maps. Using three activation maps, the convolutional hidden layer 1004 can detect three different kinds of features, with each feature being detectable across the entire image.

In some examples, a non-linear hidden layer can be applied after the convolutional hidden layer 1004. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1000 without affecting the receptive fields of the convolutional hidden layer 1004.

The pooling hidden layer 1006 can be applied after the convolutional hidden layer 1004 (and after the non-linear hidden layer when used). The pooling hidden layer 1006 is used to simplify the information in the output from the convolutional hidden layer 1004. For example, the pooling hidden layer 1006 can take each activation map output from the convolutional hidden layer 1004 and generates a condensed activation map (or feature map) using a pooling function. Max-pooling is one example of a function performed by a pooling hidden layer. Other forms of pooling functions be used by the pooling hidden layer 1006, such as average pooling, L2-norm pooling, or other suitable pooling functions. A pooling function (e.g., a max-pooling filter, an L2-norm filter, or other suitable pooling filter) is applied to each activation map included in the convolutional hidden layer 1004. In the example shown in FIG. 10, three pooling filters are used for the three activation maps in the convolutional hidden layer 1004.

In some examples, max-pooling can be used by applying a max-pooling filter (e.g., having a size of 2×2) with a stride (e.g., equal to a dimension of the filter, such as a stride of 2) to an activation map output from the convolutional hidden layer 1004. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1004 having a dimension of 24×24 nodes, the output from the pooling hidden layer 1006 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1006 to every one of the output nodes in the output layer 1010. Using the example above, the input layer includes 28×28 nodes encoding the pixel intensities of the input image, the convolutional hidden layer 1004 includes 3×24×24 hidden feature nodes based on application of a 5×5 local receptive field (for the filters) to three activation maps, and the pooling hidden layer 1006 includes a layer of 3×12×12 hidden feature nodes based on application of max-pooling filter to 2×2 regions across each of the three feature maps. Extending this example, the output layer 1010 can include ten output nodes. In such an example, every node of the 3×12×12 pooling hidden layer 1006 is connected to every node of the output layer 1010.

The fully connected layer 1008 can obtain the output of the previous pooling hidden layer 1006 (which should represent the activation maps of high-level features) and determines the features that most correlate to a particular class. For example, the fully connected layer 1008 can determine the high-level features that most strongly correlate to a particular class and can include weights (nodes) for the high-level features. A product can be computed between the weights of the fully connected layer 1008 and the pooling hidden layer 1006 to obtain probabilities for the different classes. For example, if the CNN 1000 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1010 can include an M-dimensional vector (in the prior example, M=10). M indicates the number of classes that the CNN 1000 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

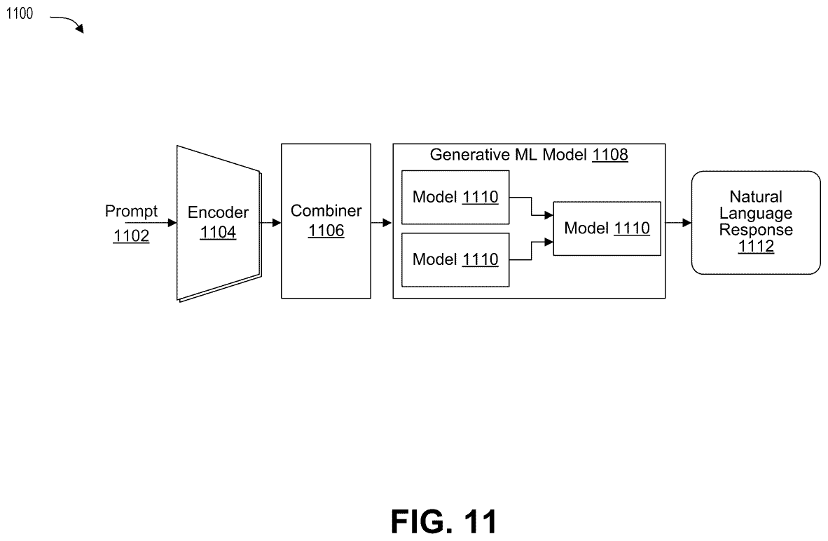

FIG. 11 is a block diagram illustrating a multimodal generative ML system 1100 for generating natural language responses based on natural language input from a prompt 1102 and any additional information. A multimodal machine learning system is a machine learning model that receives, processes, and outputs data in multiple forms. For example, the input prompt may include text, images, and audio. The LLM of FIG. 1 and/or the large language model 212 of FIG. 2A and FIG. 2B may be examples of multimodal generative ML system 1100.

For example, the multimodal generative ML system 1100 includes a plurality of encoders 1104 that are each configured to encode different modes of content (e.g., text, images, audio, etc.) into different tokens within a common embedding space. For example, a text input may be segmented based on different techniques (e.g., paragraph, sentence, etc.) and encoded by a text encoder (from the encoders 1104) into tokens. In another example, one or more images can be provided to an image encoder (from the encoders 1104) that extracts features associated with the image and generates tokens representing the visual features. In another example, audio can be provided to an audio encoder (from the encoders 1104) that extracts features associated with the image and generates tokens representing the audio features. In the case of audio, the audio encoder can identify features that can include formants that characterize resonant frequencies in speech, rhythmic features related to timing and tempo, and harmonic features that describe the relationship between fundamental frequencies and their harmonics.

The different tokens from the plurality of encoders are provided to combiner 1106. The combiner 1106 can combine the tokens based on the order in which they are presented. For example, the input into the encoder may be an array of primitive values. A primitive value is an immutable data type provided by a programming language and includes values that represent a single piece of data (e.g., number, string, Boolean, etc.) rather than a complex object or reference. A non-limiting example prompt may include a byte array (e.g., an unsigned 8-byte integer array or uint8array), and another string. The byte array may be audio, images, or other content that can be processed by the encoders 1104. In some aspects, the combiner 1106 is configured to concatenate the different tokens in order based on the array to preserve the semantic order of features and provide the tokens to the generative machine learning model 1108.

The generative machine learning model 1108 is configured to receive the tokens and generate a natural language response 1112 based on the tokens and the prompt 1102. Generative machine learning model 1108 may include one or more models 1110 (e.g., transformer neural network(s), diffusion model(s), fully connected layer(s), multilayer perceptrons (MLPs), any combination thereof, and/or other models). The one or more models 1110 of the generative machine learning model 1108 are configured to process the tokens and extract different types of features that are relevant to the prompt 1102. For example, the prompt 1102 can be a query for a particular type of information. The one or more models of the generative machine learning model 1108 can perform different tasks related to the query, such as writing code to perform a particular function, generating an image based on an input image with expressed modifications, generate an image without any input image, and so forth.

The generative machine learning model 1108 may include different components, such as a featurization engine to identify different types of features, an inference engine to identify inferences within the text (e.g., pronoun usage and corresponding disambiguation functions), data retrieval engines (e.g., to identify features related to a particular concept observed by the generative machine learning model 1108), and so forth. The generative machine learning model 1108 may also include different types of models and engines to synthesize a coherent contextual output, such as to synthesize the input content and information that is responsive to tasks embedded within the text. For example, the generative machine learning model 1108 may include a predictive output engine (not shown) that is configured to generate a sequence of words that is most likely contextually correct and to provide a coherent and contextually relevant answer. For instance, the predictive output generation engine can generate responses by sampling from the probability distribution of possible words and sequences based on patterns observed during training. The generative machine learning model 1108 may also include a predictive output generation engine to generate multiple responses that are potentially relevant and coherent with respect to the prompt 1102. The generative machine learning model 1108 may also include an output validation engine configured to evaluate the generated responses based on certain criteria. Non-limiting examples of criteria to evaluate generated responses include relevance to the prompt, coherence, fluency, and adherence to specific guidelines or rules. Based on the evaluation, the output validation engine may select and output the most appropriate response.

As noted above, the generative machine learning model 1108 may include various types of models (e.g., machine learning models), such as a transformer. A transformer is a neural network architecture that can be trained to perform one or more natural language processing (NLP) tasks, such as language translation, sentiment analysis, and text summarization. Conventional traditional recurrent neural networks (RNNs) process data in sequence. A transformer or transformer network can process input in parallel and can thus be faster and more efficient than sequential training and processing. In some aspects, a transformer can use a self-attention mechanism (e.g., one or more self-attention layers), which allows the transformer to identify the most relevant parts of the input text or content (e.g., audio or video). In some cases, a transformer can also use a cross-attention mechanism (e.g., one or more cross-attention layers) which uses other content or data to determine the most relevant parts of the input. For example, cross-attention mechanisms are useful in sequential content such as a stream of data, such as optical flow, and other computer vision techniques.

A transformer neural network can include a multi-layer encoder-decoder architecture. For instance, an encoder of the encoder-decoder architecture can receive text as input, convert the input text into a sequence of hidden representations, and capture the meaning of the text at different levels of abstraction. A decoder of the encoder-decoder architecture can then process the representations output from the decoder to generate an output sequence, such as a text translation or a summary. The encoder and decoder can be trained together using supervised learning, unsupervised learning, or a combination of supervised and unsupervised learning techniques, such as maximum likelihood estimation and self-supervised pretraining. Illustrative examples of transformer engines include a BERT model, a Text-to-Text Transfer Transformer (T5), biomedical BERT (BioBERT), scientific BERT (SciBERT), and the SPECTER model for document-level representation learning. In some aspects, multiple transformer engines may be used to generate different tokens.

In some aspects, the generative machine learning model 1108 may be executed using a neural engine (or multiple neural engines) for on-device execution, such as a neural processing unit (NPU), a neural signal processor (NSP), a digital signal processor (DSP), any combination thereof, and/or other neural engine. The neural engine can include a plurality of neural processing cores that are configured to parallelize operations associated with neural networks. A neural processing core can include arrays of multiply-accumulate (MAC) units and specialized instructions that are optimized for matrix operations, such as convolution and matrix multiplication. The neural processing core can receive input data and perform matrix transformations and nonlinear activation functions to break down and parallelize matrix operations. The neural processing core can perform tasks such as inference (e.g., runtime operation of a machine learning model) or training of deep learning models. The neural processing core can accelerate tasks by parallelization of larger computations that can be performed in parallel (e.g., matrix operations associated with neural networks). For instance, the neural engine may perform computer vision tasks such as object recognition. In some cases, the neural engine can be implemented based on various ML libraries such as PyTorch, which interfaces with the compute unified device architecture (CUDA) to parallelize operations.

In some aspects, the generative machine learning model 1108 may be a small generative model that has fewer parameters, fewer layers, fewer neurons, or a simpler architecture compared to larger models. A small generative model may not capture the full complexity of the underlying data distribution as effectively as larger models but can still be useful in scenarios where computational resources are limited or where a simpler model is sufficient for the task. Small generative models can also be easier to train and interpret, making them suitable for certain applications. For example, ChatGPT-3.5 has 175 billion parameters that results in a size of 1.4 Terabytes (TB) for a model implemented with double-precision floating point numbers. A smaller model may have a simpler architecture, use fewer parameters (e.g., 10 million), and use less precise numbers (e.g., single-precision floating point numbers) resulting in a size of 38 Megabytes (MB).

In addition, small models benefit from increased training based on local execution and data specific to a local device and a user of that local device. An additional benefit to small models is increased privacy because the information is not transmitted over the network and only relies on information requested by the user or usage at the local device.

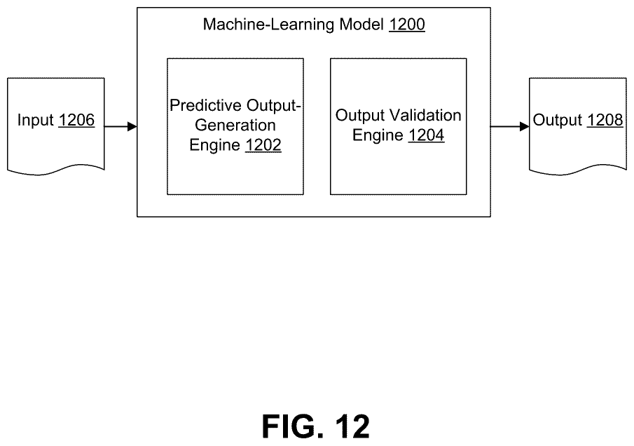

FIG. 12 includes an example machine-learning model 1200 that may be used in various aspects of the present disclosure. For example, LLM of FIG. 1 and/or the large language model 212 of FIG. 2A and FIG. 2B may be examples of machine-learning model 1200.

Machine-learning model 1200 is an example of a generative response engine. Generative response engines are commonly referred to as Generative AI. Generative response engines can receive an input prompt (e.g., input 1206) and generate content (e.g., output 1208) based on the prompt. Generative Pre-trained Transformers (GPTs), diffusion models, and diffusion-transformer models are some non-limiting examples of generative response engines.

Machine-learning model 1200 includes a predictive output-generation engine 1202 and Output validation engine 1204. Predictive output-generation engine 1202 may analyze input 1206 and identify relevant patterns and associations based on data on which predictive output-generation engine 1202 was trained. Further, predictive output-generation engine 1202 may predict a sequence of words that are the most likely continuation of input 1206. By iteratively predicting next words, predictive output-generation engine 1202 may aim to provide a coherent and contextually relevant answer to input 1206. Predictive output-generation engine 1202 may generate responses by sampling from the probability distribution of possible words and sequences, guided by the patterns observed during the training of predictive output-generation engine 1202. In some aspects, predictive output-generation engine 1202 may generate multiple possible responses before outputting a final one. The multiple responses may be variations that predictive output-generation engine 1202 considers potentially relevant and coherent. Output validation engine 1204 may evaluate the multiple generated responses based on certain criteria. These criteria can include relevance to the prompt, coherence, fluency, and sometimes adherence to specific guidelines or rules, depending on the application. Based on this evaluation, output validation engine 1204 may select a most appropriate response. This selection is typically the one that scores highest on the set criteria, balancing factors like relevance, informativeness, and coherence.

Input 1206 and/or output 1208 may be, or may include, text, image data, video data, numerical data, etc. For example, machine-learning model 1200 may perform tasks such as, text summarization, text translation, text generation, responding to queries, image description, video description, image generation (e.g., based on text and/or image data), video generation (e.g., based on text and/or image data), image rendering (e.g., based on a 3D model and/or image data), object detection (e.g., based on image data and/or video data) etc. As such, machine-learning model 1200 may be referred to as a large language model (LLM), a vision-language model (VLM), a multilingual language model (MLLM) a large vision model (LVM), etc.

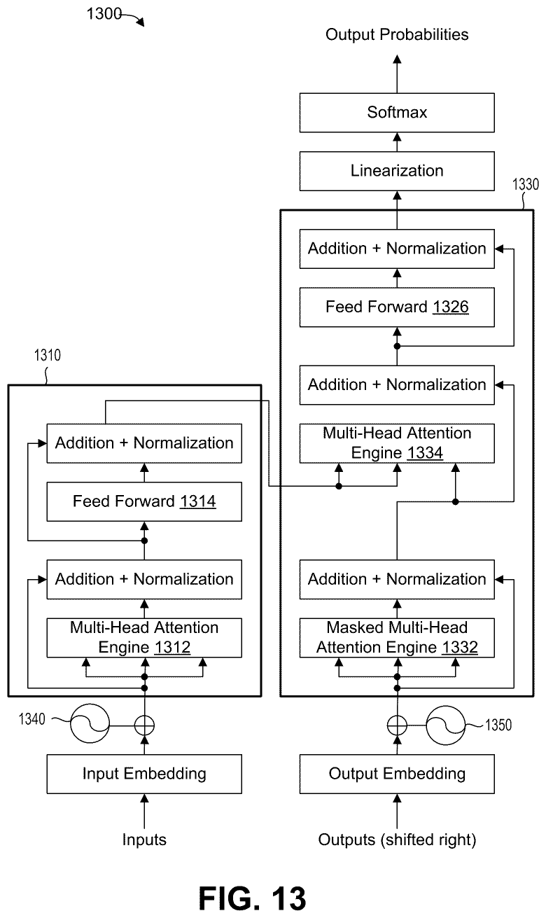

FIG. 13 is a block diagram of an example transformer 1300 in accordance with some aspects of the disclosure. Additionally, transformer 1300 may be included in multimodal generative ML system 1100 and/or machine-learning model 1200.

In a convolutional neural network (CNN) model, the number of operations required to relate signals from two arbitrary input or output positions grows in the distance between positions, which makes learning dependencies at different distant positions challenging for a CNN model. A transformer 1300 reduces the operations of learning dependencies by using an encoder 1310 and a decoder 1330 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1310 is composed of a stack of six identical layers and each layer has two sub-layers. The first sub-layer is a multi-head self-attention engine 1312, and the second sub-layer is a fully-connected feed-forward network 1314. A residual connection (not shown) connects around each of the sub-layers followed by normalization.

In this example transformer 1300, the decoder 1330 is also composed of a stack of six 6 identical layers. The decoder also includes a masked multi-head self-attention engine 1332, a multi-head attention engine 1334 over the output of the encoder 1310, and a fully-connected feed-forward network 1326. Each layer includes a residual connection (not shown) around the layer, which is followed by layer normalization. The masked multi-head self-attention engine 1332 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1340 to encode positions because the model does not contain recurrence and convolution and relative or absolute position of the tokens is needed. In the transformer 1300, the positional encodings are added to the input embeddings at the bottom layer of the encoder 1310 and the decoder 1330. The positional encodings are summed with the embeddings because the positional encodings and embeddings have the same dimensions. A corresponding position decoder 1350 is configured to decode the positions of the embeddings for the decoder 1330.

In some aspects, the transformer 1300 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1300 can process input sequences of variable length, making it well-suited for natural language processing tasks where input lengths can vary greatly. Additionally, the self-attention mechanism allows the transformer 1300 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 14 illustrates an example computing-device architecture 1400 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1400 may include, implement, or be included in any or all of system 100 of FIG. 1, system 200 of FIG. 2A and FIG. 2B, and/or other devices, modules, or systems described herein. Additionally or alternatively, computing-device architecture 1400 may be configured to perform process 800 of FIG. 8A, process 810 of FIG. 8B, and/or other process described herein.

The components of computing-device architecture 1400 are shown in electrical communication with each other using connection 1412, such as a bus. The example computing-device architecture 1400 includes a processing unit (CPU or processor) 1402 and computing device connection 1412 that couples various computing device components including computing device memory 1410, such as read only memory (ROM) 1408 and random-access memory (RAM) 1406, to processor 1402.

Computing-device architecture 1400 can include a cache of high-speed memory connected directly with, in close proximity to, or integrated as part of processor 1402. Computing-device architecture 1400 can copy data from memory 1410 and/or the storage device 1414 to cache 1404 for quick access by processor 1402. In this way, the cache can provide a performance boost that avoids processor 1402 delays while waiting for data. These and other modules can control or be configured to control processor 1402 to perform various actions. Other computing device memory 1410 may be available for use as well. Memory 1410 can include multiple different types of memory with different performance characteristics. Processor 1402 can include any general-purpose processor and a hardware or software service, such as service 1 1416, service 2 1418, and service 3 1420 stored in storage device 1414, configured to control processor 1402 as well as a special-purpose processor where software instructions are incorporated into the processor design. Processor 1402 may be a self-contained system, containing multiple cores or processors, a bus, memory controller, cache, etc. A multi-core processor may be symmetric or asymmetric.

To enable user interaction with the computing-device architecture 1400, input device 1422 can represent any number of input mechanisms, such as a microphone for speech, a touch-sensitive screen for gesture or graphical input, keyboard, mouse, motion input, speech and so forth. Output device 1424 can also be one or more of a number of output mechanisms known to those of skill in the art, such as a display, projector, television, speaker device, etc. In some instances, multimodal computing devices can enable a user to provide multiple types of input to communicate with computing-device architecture 1400. Communication interface 1426 can generally govern and manage the user input and computing device output. There is no restriction on operating on any particular hardware arrangement and therefore the basic features here may easily be substituted for improved hardware or firmware arrangements as they are developed.

Storage device 1414 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1406, read only memory (ROM) 1408, and hybrids thereof. Storage device 1414 can include services 1416, 1418, and 1420 for controlling processor 1402. Other hardware or software modules are contemplated. Storage device 1414 can be connected to the computing device connection 1412. In one aspect, a hardware module that performs a particular function can include the software component stored in a computer-readable medium in connection with the necessary hardware components, such as processor 1402, connection 1412, output device 1424, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method for generating data based on video data, the method comprising: obtaining video data comprising a plurality of frames; encoding each frame of the plurality of frames to generate a plurality of visual tokens; selecting a subset of visual tokens from among the plurality of visual tokens; and processing a query and the subset of visual tokens using a large language model to generate a response.

Aspect 2. The method of aspect 1, further comprising: concatenating the subset of visual tokens with a text embedding based on the query; and processing the concatenated subset of visual tokens and text embedding using the large language model.

Aspect 3. The method of any one of aspects 1 or 2, further comprising performing at least one of captioning, question answering, or event detection based on the video data.

Aspect 4. The method of any one of aspects 1 to 3, wherein the subset of visual tokens are selected from among the plurality of visual tokens based on a facility-location function.

Aspect 5. The method of any one of aspects 1 to 4, wherein the subset of visual tokens are selected from among the plurality of visual tokens to maximize a utility function.

Aspect 6. The method of any one of aspects 1 to 5, wherein the subset of visual tokens are selected from among the plurality of visual tokens to maximize a coverage function.

Aspect 7. The method of any one of aspects 1 to 6, wherein the subset of visual tokens are selected from among the plurality of visual tokens to maximize a cosine similarity between selected tokens of the subset of visual tokens and unselected tokens of plurality of visual tokens.

Aspect 8. The method of any one of aspects 1 to 7, wherein the subset of visual tokens are selected from among the plurality of visual tokens iteratively according to a greedy algorithm.

Aspect 9. The method of any one of aspects 1 to 8, wherein the subset of visual tokens are selected from among the plurality of visual tokens iteratively based on a highest marginal gain for selecting a next token for inclusion in the subset of visual tokens.

Aspect 10. The method of any one of aspects 1 to 9, wherein the subset of visual tokens are selected from among the plurality of visual tokens iteratively according to a lazy greedy algorithm.

Aspect 11. An apparatus for generating data based on video data, the apparatus comprising: at least one memory; and at least one processor coupled to the at least one memory and configured to perform operations according to any of aspects 1 to 10.

Aspect 12. A non-transitory computer-readable storage medium having stored thereon instructions that, when executed by at least one processor, cause the at least one processor to perform operations according to any of aspects 1 to 10.

Aspect 13. An apparatus for generating data based on video data, the apparatus comprising one or more means for perform operations according to any of aspects 1 to 10.

Aspect 14. An apparatus for generating data based on video data, the apparatus comprising: at least one memory; and at least one processor coupled to the at least one memory and configured to: encode each frame of a plurality of frames of video data to generate a plurality of visual tokens; select a subset of visual tokens from among the plurality of visual tokens; process a query to generate a text embedding; and process the subset of visual tokens and the text embedding using a large language model to generate a response to the query.

Aspect 15. The apparatus of aspect 14, wherein the at least one processor is configured to: combine the subset of visual tokens with the text embedding; and process the combined subset of visual tokens and the text embedding using the large language model to generate the response to the query.

Aspect 16. The apparatus of any one of aspects 14 or 15, wherein the at least one processor is configured to perform at least one of captioning, question answering, or event detection based on the video data.

Aspect 17. The apparatus of any one of aspects 14 to 16, wherein the response comprises a caption for the video data.

Aspect 18. The apparatus of any one of aspects 14 to 17, wherein the response comprises an answer to a question of the query based on the video data.

Aspect 19. The apparatus of any one of aspects 14 to 18, wherein the response comprises a label related to an event detected in the video data.

Aspect 20. The apparatus of any one of aspects 14 to 19, wherein the at least one processor is configured to select the subset of visual tokens from among the plurality of visual tokens based on a facility-location function.

Aspect 21. The apparatus of any one of aspects 14 to 20, wherein the at least one processor is configured to select the subset of visual tokens from among the plurality of visual tokens based on a utility function.

Aspect 22. The apparatus of any one of aspects 14 to 21, wherein the at least one processor is configured to select the subset of visual tokens from among the plurality of visual tokens based on a coverage function.

Aspect 23. The apparatus of any one of aspects 14 to 22, wherein the at least one processor is configured to select the subset of visual tokens from among the plurality of visual tokens based on a similarity between selected tokens of the subset of visual tokens.

Aspect 24. The apparatus of aspect 23, wherein the at least one processor is configured to select the subset of visual tokens from among the plurality of visual tokens further based on a similarity between unselected tokens of plurality of visual tokens.

Aspect 25. The apparatus of any one of aspects 14 to 24, wherein the at least one processor is configured to select the subset of visual tokens from among the plurality of visual tokens iteratively according to a greedy algorithm.

Aspect 26. The apparatus of any one of aspects 14 to 25, wherein the at least one processor is configured to select the subset of visual tokens from among the plurality of visual tokens iteratively based on a highest marginal gain for selecting a next token for inclusion in the subset of visual tokens.

Aspect 27. The apparatus of any one of aspects 14 to 26, wherein the at least one processor is configured to select the subset of visual tokens from among the plurality of visual tokens iteratively according to a lazy greedy algorithm.

Aspect 28. A method for generating data based on video data, the method comprising: encoding each frame of a plurality of frames of video data to generate a plurality of visual tokens; selecting a subset of visual tokens from among the plurality of visual tokens; processing a query to generate a text embedding; and processing the subset of visual tokens and the text embedding using a large language model to generate a response to the query.

Aspect 29. The method of aspect 28, further comprising: combining the subset of visual tokens with the text embedding; and processing the combined subset of visual tokens and the text embedding using the large language model to generate the response to the query.

Aspect 30. The method of any one of aspects 28 or 29, further comprising at least one of captioning, question answering, or event detection based on the video data.

Aspect 31. The method of any one of aspects 28 to 30, wherein the response comprises a caption for the video data.

Aspect 32. The method of any one of aspects 28 to 31, wherein the response comprises an answer to a question of the query based on the video data.

Aspect 33. The method of any one of aspects 28 to 32, wherein the response comprises a label related to an event detected in the video data.

Aspect 34. The method of any one of aspects 28 to 33, further comprising selecting the subset of visual tokens from among the plurality of visual tokens based on a facility-location function.

Aspect 35. The method of any one of aspects 28 to 34, further comprising selecting the subset of visual tokens from among the plurality of visual tokens based on a utility function.

Aspect 36. The method of any one of aspects 28 to 35, further comprising selecting the subset of visual tokens from among the plurality of visual tokens based on a coverage function.

Aspect 37. The method of any one of aspects 28 to 36, further comprising selecting the subset of visual tokens from among the plurality of visual tokens based on a similarity between selected tokens of the subset of visual tokens.

Aspect 38. The method of aspect 37, further comprising selecting the subset of visual tokens from among the plurality of visual tokens further based on a similarity between unselected tokens of plurality of visual tokens.

Aspect 39. The method of any one of aspects 28 to 38, further comprising selecting the subset of visual tokens from among the plurality of visual tokens iteratively according to a greedy algorithm.

Aspect 40. The method of any one of aspects 28 to 39, further comprising selecting the subset of visual tokens from among the plurality of visual tokens iteratively based on a highest marginal gain for selecting a next token for inclusion in the subset of visual tokens.

Aspect 41. The method of any one of aspects 28 to 40, further comprising selecting the subset of visual tokens from among the plurality of visual tokens iteratively according to a lazy greedy algorithm.

Aspect 42. A non-transitory computer-readable storage medium having stored thereon instructions that, when executed by at least one processor, cause the at least one processor to perform operations according to any of aspects 28 to 41.

Aspect 43. An apparatus for generating data based on video data, the apparatus comprising one or more means for perform operations according to any of aspects 28 to 41.

What is claimed is:

1. An apparatus for generating data based on video data, the apparatus comprising:
at least one memory; and
at least one processor coupled to the at least one memory and configured to:
encode each frame of a plurality of frames of video data to generate a plurality of visual tokens;
select a subset of visual tokens from among the plurality of visual tokens;
process a query to generate a text embedding; and
process the subset of visual tokens and the text embedding using a large language model to generate a response to the query.

2. The apparatus of claim 1, wherein the at least one processor is configured to:
combine the subset of visual tokens with the text embedding; and
process the combined subset of visual tokens and the text embedding using the large language model to generate the response to the query.

3. The apparatus of claim 1, wherein the at least one processor is configured to perform at least one of captioning, question answering, or event detection based on the video data.

4. The apparatus of claim 1, wherein the response comprises a caption for the video data.

5. The apparatus of claim 1, wherein the response comprises an answer to a question of the query based on the video data.

6. The apparatus of claim 1, wherein the response comprises a label related to an event detected in the video data.

7. The apparatus of claim 1, wherein the at least one processor is configured to select the subset of visual tokens from among the plurality of visual tokens based on a facility-location function.

8. The apparatus of claim 1, wherein the at least one processor is configured to select the subset of visual tokens from among the plurality of visual tokens based on a utility function.

9. The apparatus of claim 1, wherein the at least one processor is configured to select the subset of visual tokens from among the plurality of visual tokens based on a coverage function.

10. The apparatus of claim 1, wherein the at least one processor is configured to select the subset of visual tokens from among the plurality of visual tokens based on a similarity between selected tokens of the subset of visual tokens.

11. The apparatus of claim 10, wherein the at least one processor is configured to select the subset of visual tokens from among the plurality of visual tokens further based on a similarity between unselected tokens of plurality of visual tokens.

12. The apparatus of claim 1, wherein the at least one processor is configured to select the subset of visual tokens from among the plurality of visual tokens iteratively according to a greedy algorithm.

13. The apparatus of claim 1, wherein the at least one processor is configured to select the subset of visual tokens from among the plurality of visual tokens iteratively based on a highest marginal gain for selecting a next token for inclusion in the subset of visual tokens.

14. The apparatus of claim 1, wherein the at least one processor is configured to select the subset of visual tokens from among the plurality of visual tokens iteratively according to a lazy greedy algorithm.

15. A method for generating data based on video data, the method comprising:
encoding each frame of a plurality of frames of video data to generate a plurality of visual tokens;
selecting a subset of visual tokens from among the plurality of visual tokens;
processing a query to generate a text embedding; and
processing the subset of visual tokens and the text embedding using a large language model to generate a response to the query.

16. The method of claim 15, further comprising:
combining the subset of visual tokens with the text embedding; and
processing the combined subset of visual tokens and the text embedding using the large language model to generate the response to the query.

17. The method of claim 15, further comprising at least one of captioning, question answering, or event detection based on the video data.

18. The method of claim 15, wherein the response comprises a caption for the video data.

19. The method of claim 15, wherein the response comprises an answer to a question of the query based on the video data.

20. The method of claim 15, wherein the response comprises a label related to an event detected in the video data.
